(19) United States
(12) Patent Application Publication
(10) Pub. No.: US 2010/0024324 A1
(43) Pub. Date: Feb. 4, 2010

(54) ROOF EAVES ICE MELTING SYSTEM AND METHOD OF INSTALLATION

(76) Inventor: Ryan Meinzer, Midvale, UT (US)

Correspondence Address: MORRISS OBRYANT COMPAGNI, P.C., 734 EAST 200 SOUTH, SALT LAKE CITY, UT, 84102, US

(21) Appl. No.: 12/488,409

(22) Filed: Jun. 19, 2009

Related U.S. Application Data
(60) Provisional application No. 61/073,931, filed on Jun. 19, 2008.

(51) Int. Cl. E04D 13/076; B23P 11/00

(52) U.S. Cl. 52/173.1; 165/47; 29/428

(57) ABSTRACT

A roof eaves ice melting system comprising a heater between a base panel and a cover panel is disclosed. A method of installing such a system is also disclosed.

### CROSS-REFERENCE TO RELATED APPLICATION

This nonprovisional patent application claims benefit and priority under 35 U.S.C. § 119(e) of the filing of U.S. Provisional Patent Application Ser. No. 61/073,931 filed on Jun. 19, 2008, titled “ROOF EAVE ICE MELTING SYSTEM”, the contents of which are incorporated herein by reference for all purposes.

### BACKGROUND OF THE INVENTION

1. Field of the Invention

The present invention relates generally to systems for preventing the buildup of snow and ice along roof eaves. More particularly, the invention relates to systems for melting ice and/or snow that might otherwise accumulate on a roof of a structure above the eaves.

2. State of the Art

Ice and snow on the roof of a house or building melts as heat from the building warms the roof. Water from the melting ice and snow then runs to the lower edges, or “eaves” of the roof where it tends to refreeze because it lacks the indirect heating from the building. This refrozen water may form an ice dam at the roof edge, and possibly in a rain gutter attached thereto, that may cause damage to the house or building structure because additional water from melting snow may pool up and seep through the roof into the house, thereby causing damage to drywall, insulation, etc. Accumulating water may cause the size and weight of the ice dam to increase, causing further damage. Additionally, water that refreezes may form stalactites that may injure or cause damage to people and property if they release from the eaves.

Various de-icing systems are known in the art for melting ice and snow from gutters mounted to a roof edge. Among such conventional systems are heating cables placed on roof edges and within gutters and downspouts. Conventional heating cables are typically routed in zig-zag patterns along the outside of shingles adjacent to a roof edge or eaves. Such heating cables are directly attached to the roof edge and therefore may damage roof surfaces if replacement or servicing becomes necessary. The efficiency of such heating cables is also highly dependent on the layout of the heating cable along the roof surface.

U.S. Pat. No. 2,699,484 to Michaels discloses a de-icer for roofs comprising a hollow shingle-shaped casing forming an extension of a roof that attaches to the trim boards of the roof and having an electrically conductive conduit in the casing.

U.S. Pat. No. 3,691,343 to Norman discloses a modular system formed of sheet metal de-icing shingles and valley sections for preventing the build-up of ice at the eaves of a roof having fine heater-wires arranged in a generally trapezoid configuration under the surface of the shingles.

U.S. Pat. No. 4,769,526 to Taouil discloses a roof de-icing panel which replaces one or more lower courses of shingles. The device of Taouil includes a perforated metal portion extending from the gutter to prevent debris from clogging the gutter, but it does not melt snow or ice flowing into it.

U.S. Pat. No. 5,391,858 to Tourangeau et al. discloses an ice dam melting system in the form of a hollow heat cell panel that replaces the last course of shingles at the edge of the roof. Tourangeau et al. further discloses a conduit supported by the lower panel, an upper panel formed of metal connected to and supported by said conduit, and a heat-generating mechanism in the conduit.

U.S. Pat. No. 5,786,563 to Tiburzi discloses modular ice and snow removal panels with gutter exclusion valves for removing snow and ice. The Tiburzi system includes a series of panels aligned in end-to-end fashion along a roof eave and atop the edge rows of shingles. The panels each include internally arrayed heating elements and an electrically operated valve element proximate a lower edge for the purpose of channeling melted ice and snow either into or over a conventionally secured gutter.

U.S. Pat. No. 6,166,352 to Turton discloses an ice shield for eaves of a roof comprising at least one continuously wound roll of a flexible and elongate mat of material which includes a first exposed face and a second reverse side face. The elongate mat is constructed of first and second layers of a durable rubberized material capable of convecting heat generated by generally longitudinal extending coils embedded between the layers. An adhesive coating is applied to the reverse side face and covered with a release tape. The mat is unrolled and positioned atop and along an eave edge location of the roof. The ice shield is installed underneath one or more initial rows of shingles to melt ice deposits. However, on existing homes, shingles have to be removed to install the mat. Once the Turton system is installed, there is no convenient way of accessing the heating coils for servicing if needed.

In view of the above-referenced conventional ice dam melting systems, there still exists a need in the art for a roof eaves ice melting system and method of installation having useful features including ease of installation and servicing of the heater and that is formed of modular components that may be extended along any length of roof eaves.

### SUMMARY OF THE INVENTION

A roof eaves ice melting system is disclosed, according to the present invention. The system may include a base panel adapted for installation on a top surface of roof eaves, the base panel further including a spring-loaded catch along an upper end and a lower end configured to wrap around a roof edge. The system may further include a heater retaining panel comprising a retainer hook configured to engage the spring-loaded catch at one edge and configured with a heater retainer member at an opposite edge. The system may further include a heater configured for resting on the heater retaining panel and adjacent to the heater retainer member, the heater further configured for selectively generating heat sufficient to melt ice or snow. The system may further include a removable cover panel comprising a cover hook configured for engaging the spring-loaded catch and configured for enclosing the heater between the base panel and the removable cover panel.

An embodiment of a method of installing a roof eaves ice melting system on roof eaves is disclosed, according to the present invention. The method may include providing the roof eaves ice melting system as described above. The method may further include attaching the base panel to a roof top and roof edge. The method may further include attaching the heater retaining panel to the base panel. The method may further include placing the heater on the heater retaining panel. The method may further include attaching the removable cover panel to the base panel and enclosing the heater.

Another embodiment of a roof eaves ice melting system is disclosed, according to the present invention. The system may include a base panel for installation on a top surface of roof eaves, the base panel comprising a first hook at an upper end and a second hook at a lower end, the second hook configured to wrap around a drip edge. The system may further include a heater, wherein the heater includes a heater core and a heating element in thermal communication with the heater core. The system may further include a removable cover panel having an upper hook configured for mechanical engagement with the first hook and a lower hook configured for wrapping around the first hook and the heater, the cover panel further configured for encasing the heater between the cover panel and the base panel.

### BRIEF DESCRIPTION OF THE DRAWINGS

The following drawings illustrate exemplary embodiments for carrying out the invention. Like reference numerals refer to like parts in different views or embodiments of the present invention in the drawings.

FIG. 1 is an exploded cross-sectional view of components of an embodiment of a roof eaves ice melting system according to the present invention.

FIG. 2 is a cross-sectional view of an embodiment of an assembled and installed roof eaves ice melting system according to the present invention.

FIG. 3 is a perspective view of an embodiment of a D-style drip edge of a base panel shown adjacent a roof edge, according to the present invention.

FIG. 4 is a perspective view of an upper end of an embodiment of a base panel shown with an embodiment of a heater retaining panel engaged to an embodiment of a spring-loaded catch, according to the present invention.

FIG. 5 is a perspective view of an embodiment of a base panel with a heater retaining panel engaged with spring-loaded catch, according to the present invention.

FIG. 6 is a perspective view of an embodiment of heater core 196 which may form part of a heater 110 (FIGS. 1-2), according to the present invention.

FIG. 7 is a perspective view of an embodiment of a heater core with heat cable threaded through channels in the heater core, according to the present invention.

FIG. 8 is a perspective view of an embodiment of a cover panel shown installed over a heater as a complete roof eaves ice melting system.

FIG. 9 is a perspective view of another embodiment of a cover panel with edge members for enclosing an edge of a roof eaves ice melting system, according to the present invention.

FIGS. 10A and 10B are perspective close-up views of embodiments of cover hooks formed in a cover panel, according to the present invention.

FIG. 11 is a cross-sectional view of another embodiment of a roof eaves ice melting system according to the present invention.

FIG. 12 is a cross-sectional view of an embodiment of a base panel secured to fascia boards according to the present invention.

FIG. 13 is a cross-sectional view of an embodiment of a heat core retaining panel for use with a roof eaves ice melting system according to the present invention.

### DETAILED DESCRIPTION OF THE INVENTION

In its most general system embodiment, the invention is a roof eaves ice melting system and method of installation. The system is particularly useful for melting or preventing the build-up of ice dams along the eaves of houses. The components of the system are modular and allow for servicing and inspection as needed.

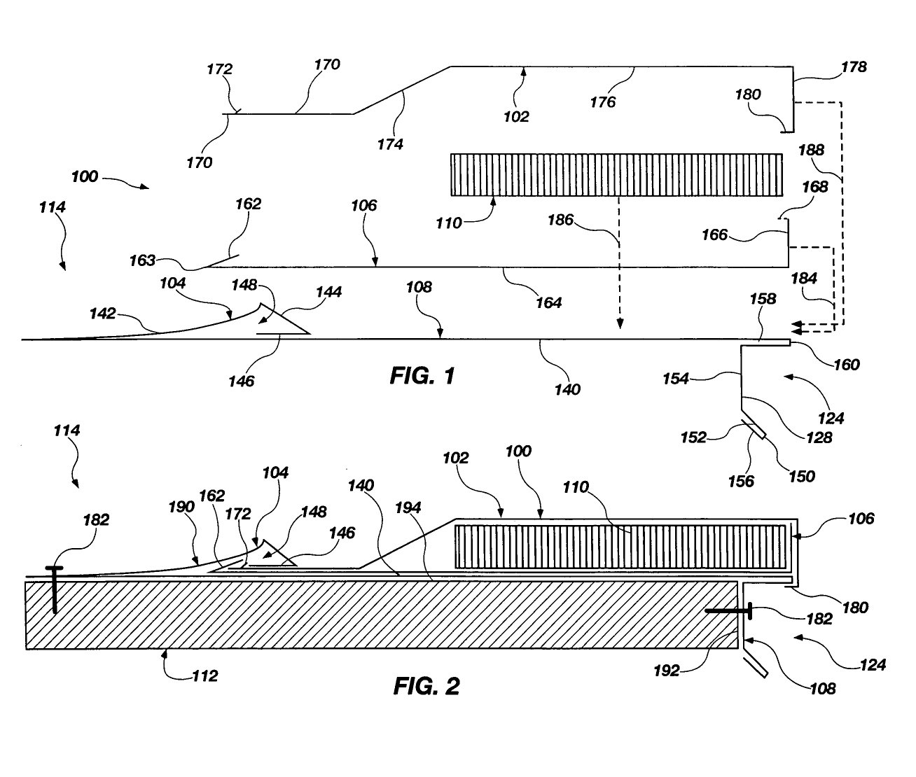

FIG. 1 is an exploded cross-sectional view of components of an embodiment of a roof eaves ice melting system 100 according to the present invention. System 100 is a “panel-type” roof eaves ice melting system including four main components, a removable cover panel 102, a heater 110, a heater retaining panel 106, and a base panel 108. The components (102, 106, 108 and 110) of system 100 are not necessarily shown to scale or with actual bends, curvature or relative sizes in FIGS. 1 and 2 as described in greater detail below. Rather the components of system 100 and their related features may be exaggerated in the drawings for illustrative purposes. Additionally, the embodiments of system 100 shown in FIGS. 1 and 2 are illustrated horizontally for simplicity, when in fact they are generally oriented along the pitch of a roof line when installed.

The base panel 108, heater retaining panel 106 and cover panel 102 may each be formed from sheet metal or other heat conducting materials that have the characteristics described herein. For example, and not by way of limitation, suitable sheet metals for use in forming the base panel 108, heater retaining panel 106 and cover panel 102 may include copper, steel, tin and aluminum or any other metal. Suitable sheet metal materials may be bent using sheet metal bending machines or other devices and methods known to those skilled in the art to form the cross-sectional members illustrated by example in FIG. 1.

The base panel 108 is configured to be mounted to the roof eaves of a structure with a lower end 124 extending over, and abutting against the roof edge or fascia boards. The base panel 108 may be formed from a single sheet of metal cut to a specified width, according to one embodiment. Alternatively, any width of roof eaves ice melting system 100 may be achieved by mounting individual base panels 108 side to side along roof eaves. The remaining components (cover panel 102, heater 110 and heater retaining panel 106) of system 100 are configured to attach to the base panel 108. The base panel 108 may be formed by bending and/or welding and/or riveting planar rectangular sheets of metal to form a D-style drip edge 128 at the lower end 124 and a spring-loaded catch 104 at the upper end 114.

The spring-loaded catch 104 may be connected to the D-style drip edge by a generally flat roof member 140. The spring-loaded catch 104 may include a curved (shown) or straight (not shown) spring member 142 between the flat roof member and leading member 144. Leading member 144 supports a base hook 146 which extends back toward upper end 114. A locking region 148 is formed in the space surrounded by curved spring member 142, leading member 144, base hook 146 and flat roof member 140 at the upper end 124.

The D-style drip edge 128 is configured to butt against a roof edge or fascia board and directs water from the roof on to a lip 150 that may be a single layer of metal 152 extending from a fascia member 154 or may be folded on itself (shown at 156) for greater strength and improved cosmetic appearance. The D-style drip edge 128 includes a drip edge 160 which is formed by drip member 158 folding back on roof member 140. The drip edge 160 may be generally perpendicular to fascia member 154, as shown the illustrated embodiment. But, it will be understood that the perpendicular relationship between the drip edge 160 and fascia member 154 is not a requirement for other embodiments of the invention.

The heater retaining panel 106 is configured to support the heater 110, thus preventing the heater 110 from falling off the roof during and after installation. The heater retaining panel 106 may include a heater support member 164 disposed between a retainer hook 162 and a heater retainer member 166. A retainer leading edge 163 is disposed at the interface between the retainer hook 162 and the heater support member 164. During installation of the heater retaining panel 106, the retainer leading edge 163 may be used to insert the retainer hook 162 into the locking region 148 of the spring-loaded catch 104 by insertion between the base hook 146 and the flat roof member 140.

Heater 110 is configured to rest on top of heater support member 164 and adjacent to heater retainer member 166. The heater retainer member 166 prevents the heater 110 from falling off of the roof eaves. The heater retaining panel 106 may be of any width according to various embodiments, and need not be of the same width as the heater 110, according to a particular embodiment of the invention. According to another embodiment of system 100, heater retaining panel 106 may optionally include a retainer lip 168 (shown in dotted line) extending from the heater retainer member 166 and generally parallel to the heater support member 164 for further securing the heater 110 in place. However, it will be understood that a retainer lip 168 is not required for a heater retaining panel 106 of the present invention. Heater retainer member 166 is shown perpendicular to heater support member 164. However, other angular orientations may also provide sufficient retention of the heater 110 according to other embodiments of the present invention.

Cover panel 102 is configured to enclose the heater 110 against the heater retaining panel 106 and base panel 108, thereby forming a relatively waterproof environment for the heater 100. Rain and melting water from snow and ice from the roof generally drains from the engagement member 170 with cover hook 172, along the angled member 174, cover member 176 and finally down toward the cover retainer member 178 and cover lip 180. Engagement member 170 and cover hook 172 are configured for insertion into the locking region 148 of the spring-loaded catch 104 by insertion between the base hook 146 and retainer panel 106 and/or the flat roof member 140 of base panel 108. In this way, the cover hook 172 (like the retainer hook 162) is configured to catch against base hook 146 and thereby be held in place at the upper end 114.

According to one embodiment, cover hook 172 may be formed by deforming the surface of engagement member 170, by punching with a scratch awl and bending the cover hook 172 up from the engagement member 170. According to other embodiments, cover hook may be formed using a punch or riveter, or by spot welding tangs to the engagement member 170. It will be readily apparent that there are other suitable means for forming a cover hook 172.

FIG. 2 is a cross-sectional view of an embodiment of an assembled and installed roof eaves ice melting system 100 according to the present invention. Referring collectively to FIGS. 1 and 2, installation of the system 100 on a roof 112 will be explained. As shown in FIG. 2, base panel 108 is configured to be attached to roof top 194 and roof edge 192. According to the illustrated embodiment, the upper end 114 of base panel 108, namely roof member 140 and curved spring member 142, may be attached to the roof using a fastener 182. Similarly, the fascia member 154 of base panel 108 may be attached to the roof using a fastener 182. According to various embodiments, fasteners 182 may be screws, brads, nails or any other suitable mechanism for securing the base panel 108 to the roof 112 and lower end 124 or fascia board(s) (not shown in FIG. 2).

Referring again to FIG. 1, installation of system 100 continues with the insertion of the heater retaining panel 106 and retainer hook 162 into locking region 148 as shown in FIG. 1 with dashed arrow 184 and as described above. With the heater retaining panel 106 in place, the heater 110 may be placed on top of the heater retaining panel 106 as shown in FIG. 1 with dashed arrow 186, and then connected to a power source such as electricity in a manner known to those of ordinary skill in the art.

The installation is completed by installation of the cover panel 102. First, the engagement member 170 with cover hook 172 is inserted into the locking region 148. Then the cover member 176 and the cover retainer 178 are wrapped over the heater 110 as shown in FIG. 1 with reference to dashed arrow 188. Finally, the cover lip 180 is secured around to the base panel 108. Using an embodiment of a cover panel 102 formed from sheet metal, the cover retainer 178 and cover lip 180 may also provide some spring tension to hold the cover panel 102 in place at the lower end 124. As can be seen in FIG. 2, the cover panel may surround up to three surfaces of heater 110. Similarly, the heater retaining panel may surround two or more surfaces of heater 110. Angled member 174 of cover panel 102 is configured to facilitate the draining of water, snow and ice to the lower end 124.

A useful feature of the spring-loaded catch 104 is that curved spring member 142 provides a spring bias, shown as arrow 190 against the cover panel 102, heater retaining panel 106 and flat roof member 140. Though spring-loaded catch 104 and the panel features that interface with it have been described with some particularity, it will be understood that various other schemes for securing the panels together at the upper end 114 will be known to those of skill in the art, such as clamps, hooks, screws, hinges and the like, are considered functional equivalents to the spring-loaded catch 104, and are within the scope and spirit of the present invention.

Removal of the cover panel 102 may be facilitated by using a screw driver or other implement to pry up the spring-loaded catch 104 to allow removal of the cover panel 102, heater 110 and heater retaining panel 106 components, if necessary for maintenance of the heater 110. It should be readily apparent that the heater 110 is protected from the elements (rain, snow, wind, dust, etc.) by its enclosure within system 100 as illustrated in FIGS. 1 and 2. Another useful feature of system 100 is the modularity of the components (base panel 108, heater retaining panel 106, heater 110 and cover panel 102, etc.) such that they may be individually accessed and replaced if necessary or desired.

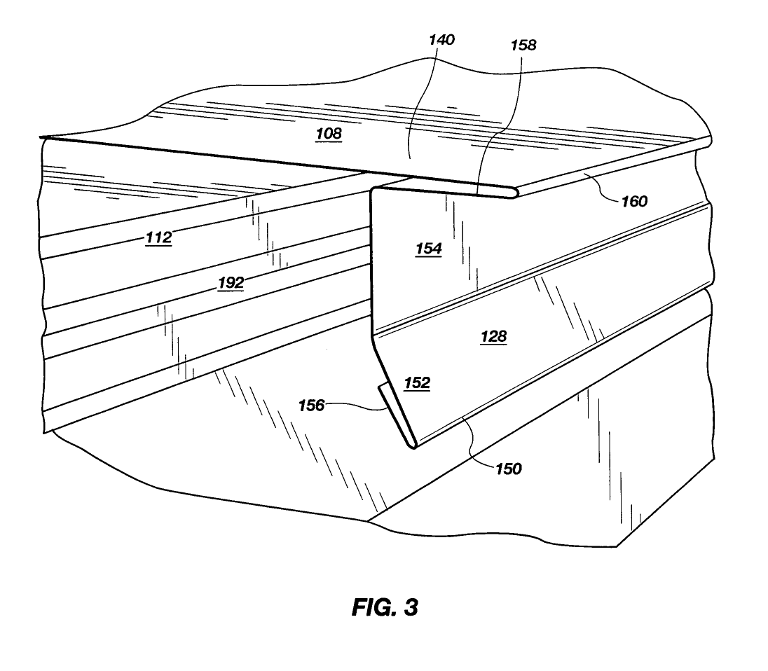

FIGS. 3-9 and FIGS. 10A-10B are perspective views of various components of another embodiment of a roof eaves ice melting system illustrating some of the features of system 100 and some additional features according to the present invention. More particularly, FIG. 3 is a perspective view of an embodiment of a D-style drip edge 128 of a base panel 108 shown adjacent a roof edge 192, according to the present invention. The D-style drip edge 128 may include drip member 158 extending back from roof member 140 at drip edge 160, fascia member 154 extending from drip member 158, a single layer of metal 152 which may be folded on itself 156 to form lip 150. The D-style drip edge 128 and other features (such as the spring-loaded catch 104, not shown) of base panel 108 may be formed by bending sheet metal, for example copper, in a configuration that allows water to drip off the roof 112 and away from the building structure (walls, etc.)

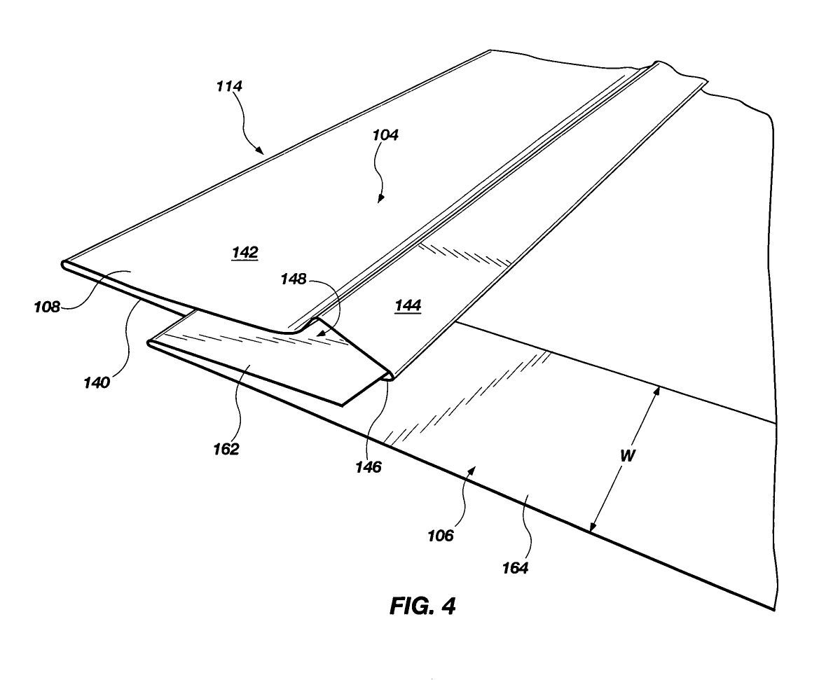

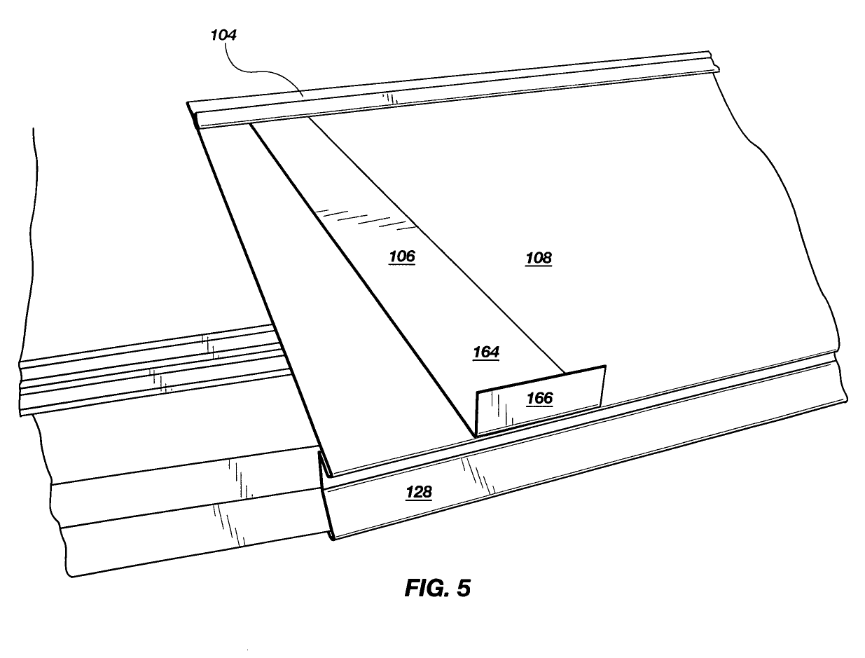

FIG. 4 is a perspective view of an upper end 114 of an embodiment of a base panel 108 shown with an embodiment of a heater retaining panel 106 engaged to an embodiment of a spring-loaded catch 104 according to the present invention. As shown in FIG. 4, the spring-loaded catch 104 may include curved spring member 142 curving back from flat roof member 140. A leading member 144 extends from curved spring member 142. Additionally, base hook 146 extends from leading member 144. Flat roof member 140, curved spring member 142, leading member 144 and base hook 146 enclose locking region 148. FIG. 4 further shows retainer hook 162 of heater retaining panel 106 engaged with the locking region 148. Retainer hook 162 extends back from heater support member 164 at an acute angle. Heater retaining panel 106 may be any suitable width, w, up to and including the width of base panel 108.

FIG. 5 is a perspective view of an embodiment of a base panel 108 with a heater retaining panel 106 engaged with spring-loaded catch 104, according to the present invention. As shown in FIG. 5, heater retaining panel 106 may include heater retainer member 166 extending, for example in a perpendicular direction, from heater support member 164. Heater retainer member 166 may be installed adjacent to D-style drip edge 128 of base panel 108.

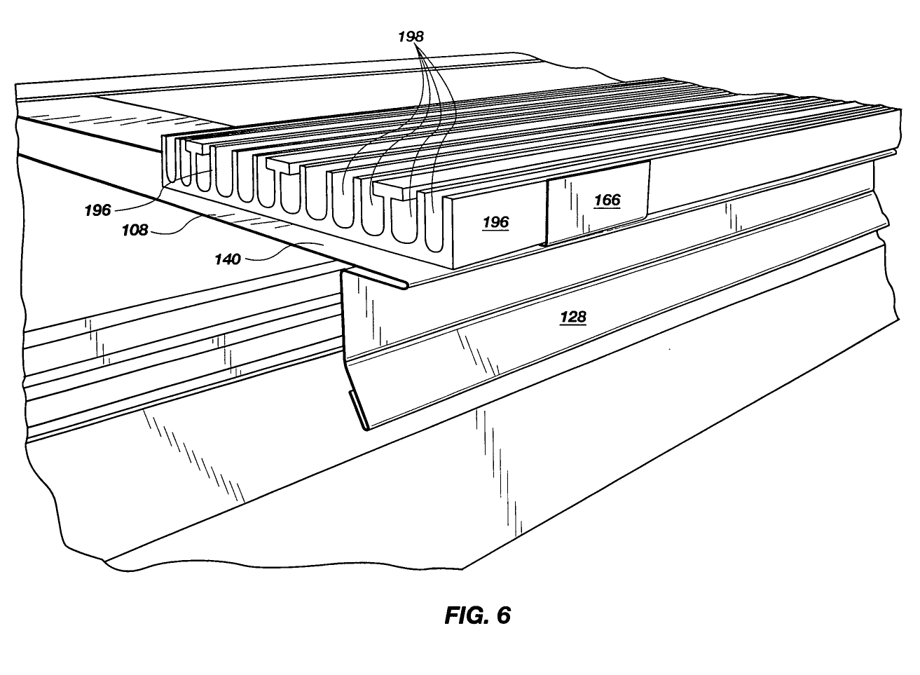

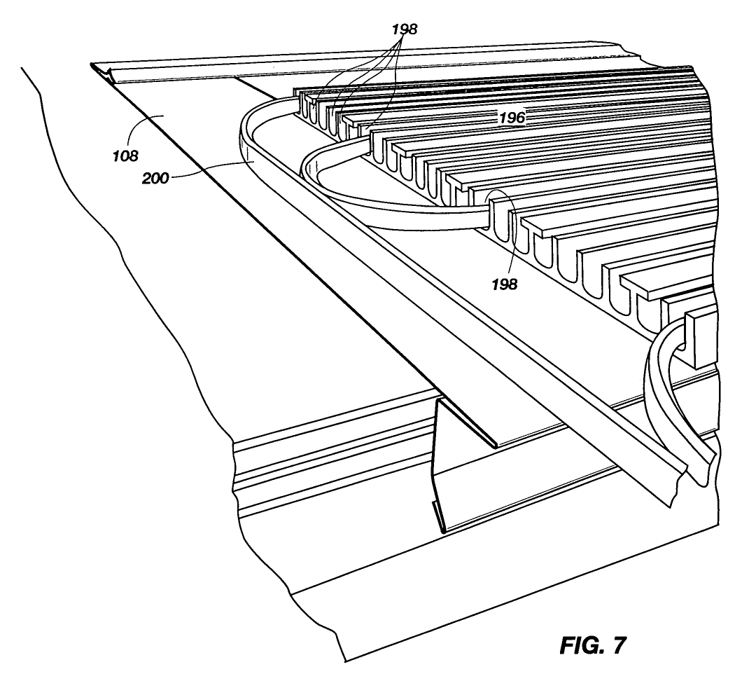

FIG. 6 is a perspective view of an embodiment of heater core 196 which may form part of a heater 110 (FIGS. 1-2), according to the present invention. Heater core 196 may be a channeled 198 block of aluminum or other heat conductive material suitable for radiating heat. The channels 198 may be used to wrap heat tape or heat cables (neither shown in FIG. 6) that provide a heat source that can be radiated by heater core 196. Heater core 196 is shown in position on the heater retaining panel 106 (obscured underneath heater core 196) which is in turn on the base panel 108. Heater retainer member 166 holds the heater core 196 in place, so that it does not slide off of a pitched roof and to the ground under the effect of gravity. According to alternative embodiments, other means may be used to secure the heater core 196 onto the base panel 108, for example tangs (not shown) could be riveted or spot welded to the flat roof member 140 that could serve the same purpose as heater retaining panels 106 and their associated heater retaining members 166. Such equivalent retaining structures are believed to be within the scope of the present invention and the functionality of heater retaining panels 106. Once the heater core 196 is in place and secured, e.g., by one or more heater retaining panels 106, it is ready to receive installation of the heat source. An aluminum block heater core 196 is illustrated in FIG. 6. However, suitable alternative heater core materials may include concrete-like planking material and plastic heater cores.

FIG. 7 is a perspective view of an embodiment of a heater core 196 with heat cable 200 threaded through channels 198 in the heater core 196, according to the present invention. During installation of system 100 (FIG. 1) sufficient heat cable 200 may be placed within channels 198 of heater core 196 to provide enough heat to melt snow and ice by radiant heating of all thermally conductive components, including cover panel 102 (not shown in FIG. 7). The heat cable 200 may be connected to an electricity source and controller (neither shown) for selectively controlling the heating of system 100. Once the heat cable has been installed, the system 100 is ready for installation of cover panel 102 (FIG. 1).

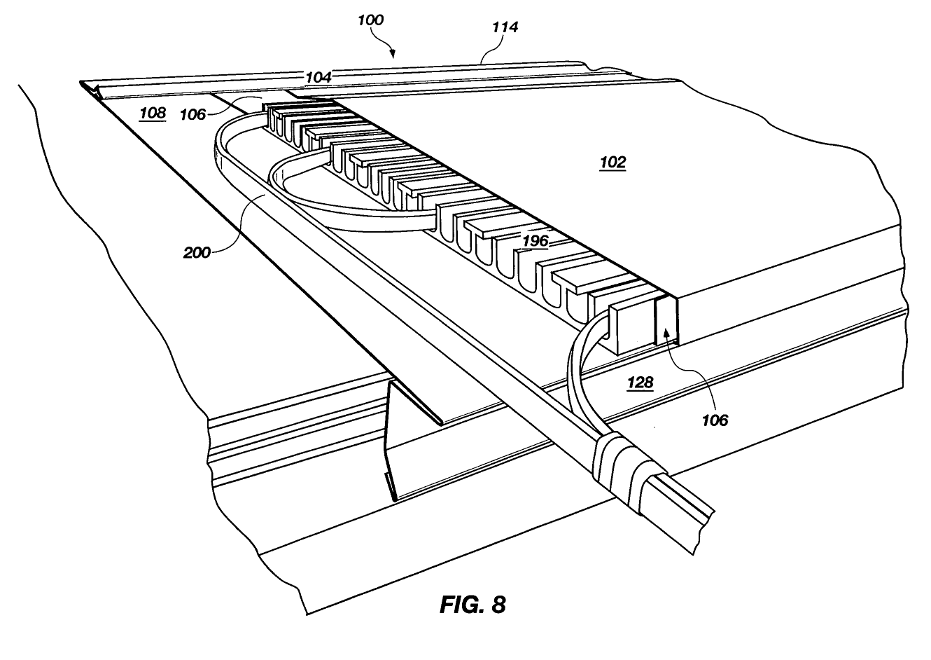

FIG. 8 is a perspective view of an embodiment of a cover panel 102 shown installed over a heater 110 (i.e., heater core 196 and heat cable 200) as a complete roof eaves ice melting system 100. As shown in FIG. 8, cover panel 102 encloses the heater core 196 and heat cable 200, which in turn rest on heater retaining panel 106, which in turn rests on base panel 108. As installed, the cover panel 102 and heater retaining panel 106 are engaged with spring-loaded catch 104 at upper end 114. As can be appreciated, the heater core 196 and heat cable 200, when completely covered, are protected from the elements and may be easily accessed for servicing.

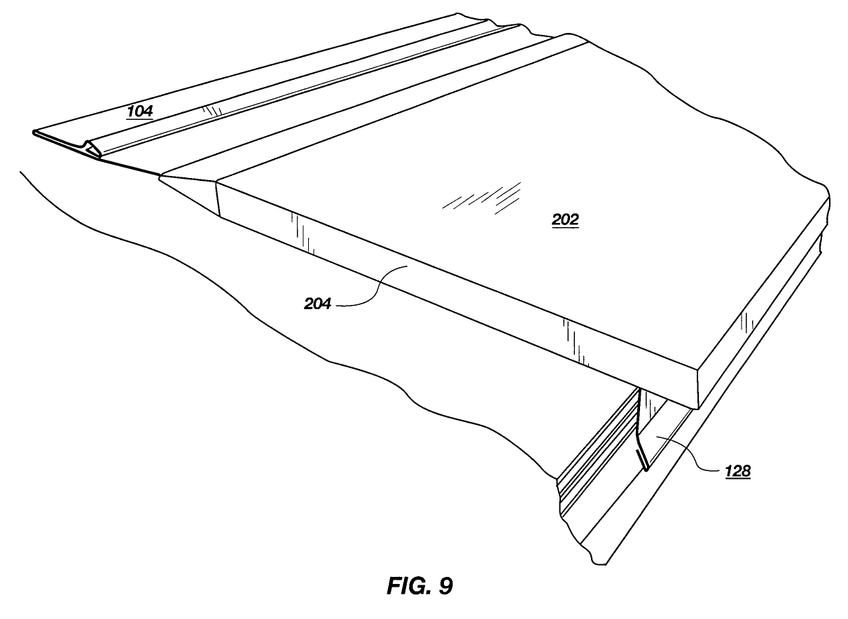

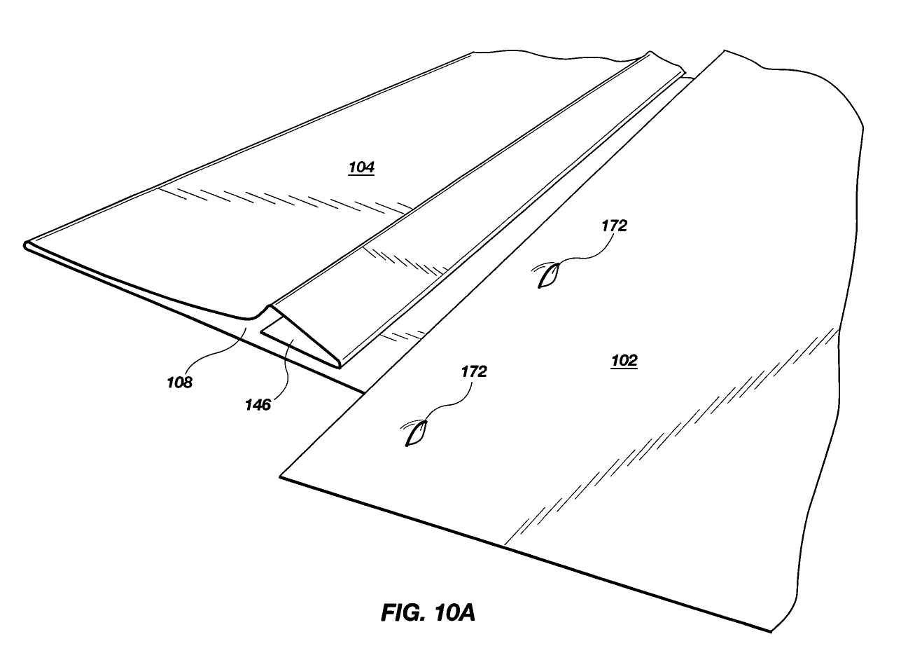

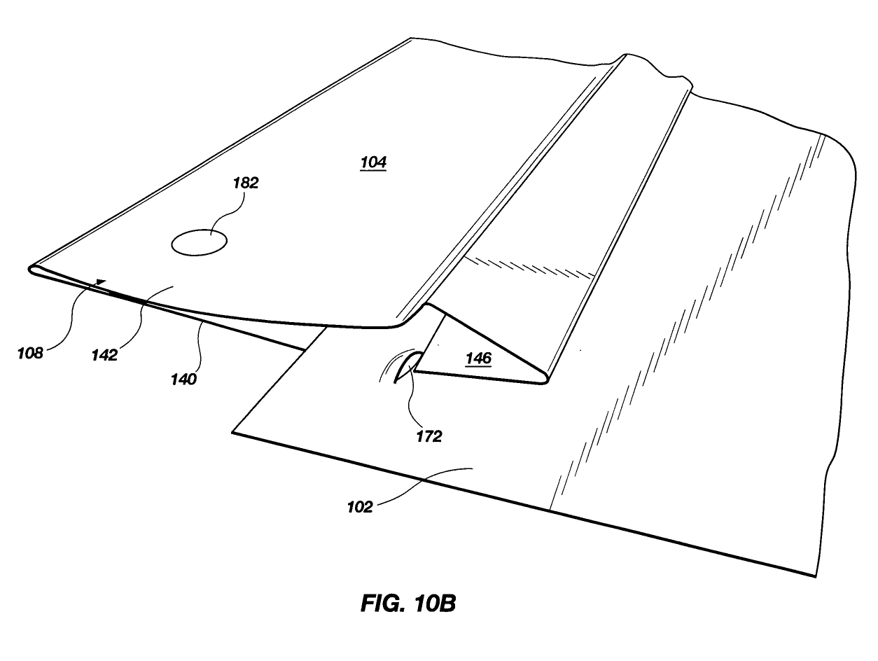

FIG. 9 is a perspective view of another embodiment of a cover panel 202 with edge members 204 for enclosing an edge of system 100, according to the present invention. It will be readily apparent that a counterpart cover panel (not shown) may be used on the opposite edge of system 100 for complete enclosure of the heater 110 (FIG. 1). FIGS. 10A and 10B are perspective close-up views of embodiments of cover hooks 172 formed in cover panel 102, according to the present invention. Cover hooks 172 are configured to interfere with base hook 146 when cover panel 102 is installed. FIG. 10B also illustrates a fastener 182 (nail head illustrated) installed through flat roof member 140 and curved spring member 142 to hold the base panel 108 in place.

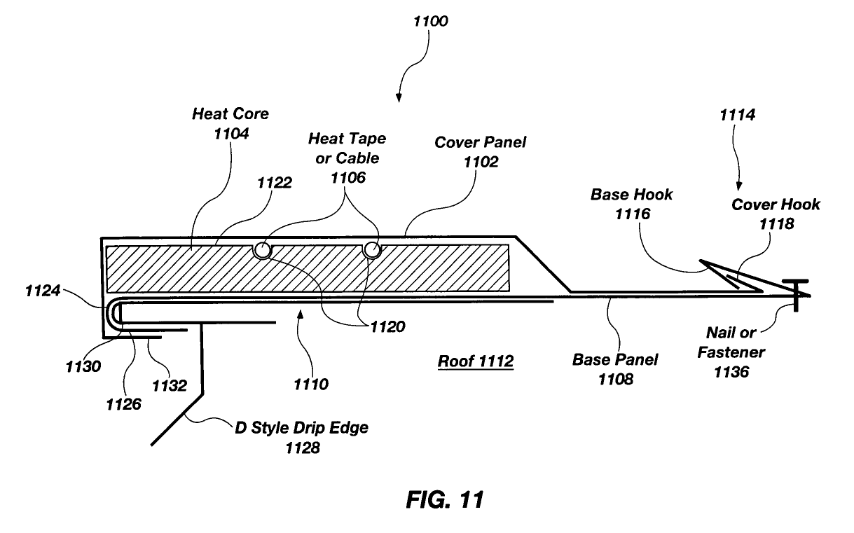

FIG. 11 is a cross-sectional view of another embodiment of a roof eaves ice melting system 1100 according to the present invention. System 1100 is also a “panel-type” roof eaves ice melter, consisting of four main components: a cover panel 1102, a heat core 1104, a heating element 1106 (two heating cable cross-sections shown), and a base panel 1108. The heating element 1106 may be heat tape, heating tubing, heat cable or any other type of heating element known to those of skill in the art. The heat core 1104 and heating element 1106 form a heater, shown generally at 1110. Each of the four components are designed to work together to form a weather-tight seal, protect the heater 1110 from damage, and preserve the appearance of the roof 1112 upon which the system 1100 is installed.

Cover panel 1102 can be made of copper, steel, or aluminum sheet metal or any other suitable metal according to various embodiments of the present invention. According to other embodiments, cover panel 1102 may be produced in varying colors, widths, and lengths in order to match existing shingle lap distances, other sheet metal features, or to suit architectural design. The upper end (toward the top of the roof, shown generally at arrow 1114) has a downward-pointing base hook 1116 meant to secure the cover panel 1102 by its upward-pointing cover hook 1118 to the base panel 1108 without nails, screws, or other fasteners that may cause the roof 1112 to leak. These hooks 1116 and 1118 simplify removing the cover panel 1102 so that the heating element 1106 and/or heat core 1104 can be inspected, repaired or replaced when necessary. Cover panel 1102 further includes a lower hook 1132 configured for wrapping around the hook 1126 of base panel 1102 and also the heater 1110.

According to one presently preferred embodiment, the heat core 1104 is formed of a concrete-like planking material. According to one embodiment, the heat core 1104 is formed with grooves 1120, molded or machined into an upper surface 1122. This concrete-like planking material is particularly advantageous when using copper sheet metal for the cover 1102 or base 1108 panels, since the planking material does not contribute to galvanic reaction or electrolysis with the surrounding cover 1102 and base 1108 panels or the heating element 1106 itself.

However, other embodiments of heat core 1104 material will have thermal conductivity characteristics that promote sustained heating to a temperature, t, sufficient to melt ice, i.e., t>32° F. Another embodiment, plastic planking with grooves, is less expensive but not as effective at retaining or distributing heat because of the nature of the plastic material. Yet another embodiment, extruded aluminum blocks with channels molded in, is designed to provide several different configurations and concentrations of the heat tape. It will be appreciated that any one of these aforementioned materials may be used as a heat core material.

The base panel 1108 may be formed from the same material as the cover panel 1102, according to embodiments of the present invention. The base panel 1108 is configured with dimensions to mate with the cover panel 1102 so that the cover panel 1102 can properly lock into the base panel 1108 without the use of fasteners that penetrate the roof 1112.

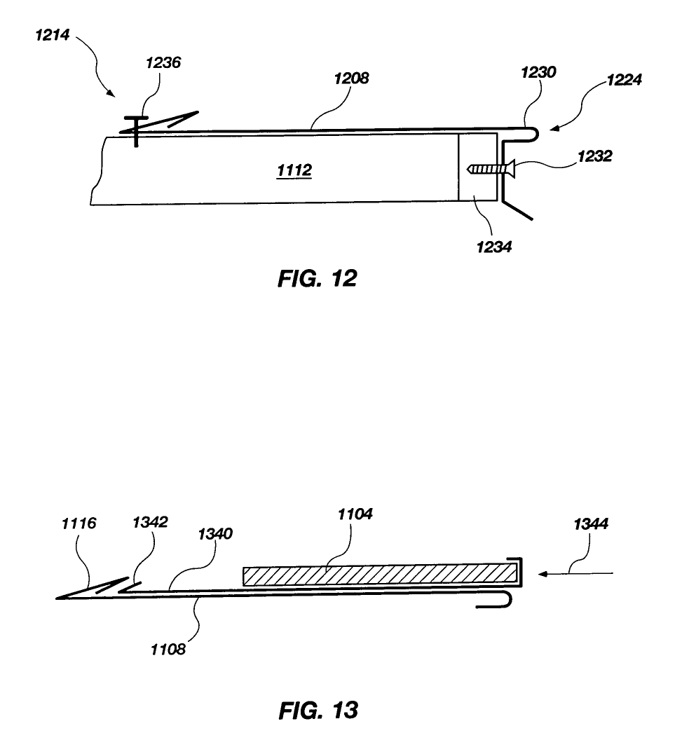

According to the embodiment illustrated in FIG. 11, the lower end 1124 of the base panel 1108 is formed with a hook 1126 for wrapping around a lip 1130 of a D-style drip edge 1128. FIG. 12 illustrates an alternative embodiment of base panel 1208. Base panel 1208 is configured to be screwed (or nailed) 1232 to the fascia boards 1234 at the edge of the roof 1112. Base panel 1208 has a lip 1230 at lower end 1224. The upper end 1214 of base panel 1208 may be nailed 1236 to the roof 1112.

As shown in FIGS. 11 and 12, the upper ends 1114, 1214 of the base panels 1108 and 1208 may be configured for nailing 136, 1236 into place in an area to be covered by the roofing material, i.e. shingles, metal roofing panels, etc. The same is true of the embodiments of system 100 illustrated in FIGS. 1-9 and FIGS. 10A-10B.

According to yet another embodiment illustrated in FIG. 13, a heat core retaining panel 1340 may be used between the base panel 1108 and the cover panel 1102 to secure the heat core 1104 in position on the base panel 1108 (or 1208, FIG. 12) during installation. The heat core retaining panel 1340 may include a hook 1342 for engaging base hook 1116 of the base panel 1108. To use the heat core retaining panel 1340, it is simply pushed up (see arrow 1344) against the base panel 1108 until the hook 1342 engages base hook 1116. With the heat core retaining panel 1340 installed, the head core 1104 may be placed in position for installation of the heating element 1106 into the heat core 1104.

The final stage of installing the roof eaves ice melting system 1100 includes installation of one or more cover panels 1102 to cover the heater 1110 (FIG. 11). This can be accomplished by installing a plurality of cover panels 1102, cut to length and pulled or pushed into position over the heater 1110 (FIG. 11). Seams between adjacent cover panels 102 may be covered or sealed with tape or other suitable splice covers if desired.

While the foregoing advantages of the present invention are manifested in the detailed description and illustrated embodiments of the invention, a variety of changes can be made to the configuration, design and construction of the invention to achieve those advantages. Hence, reference herein to specific details of the structure and function of the present invention is by way of example only and not by way of limitation.

What is claimed is:

1. A roof eaves ice melting system, comprising:
a base panel adapted for installation on a top surface of roof eaves, the base panel further including a spring-loaded catch along an upper end and a lower end configured to wrap around a roof edge;
a heater retaining panel comprising a retainer hook configured to engage the spring-loaded catch at one edge and configured with a heater retainer member at an opposite edge;
a heater configured for resting on the heater retaining panel and adjacent to the heater retainer member, the heater further configured for selectively generating heat sufficient to melt ice or snow; and
a removable cover panel comprising a cover hook configured for engaging the spring-loaded catch and configured for enclosing the heater between the base panel and the removable cover panel.

2. The system of claim 1, wherein the lower end of the base panel comprises a D-style drip edge configured for attachment to the roof edge.

3. The system of claim 1, wherein the spring-loaded catch comprises a curved spring member extending at an acute angle from a flat roof member, a leading member extending from the curved spring member and toward the flat roof member and finally a base hook extending from the leading member and back toward the upper end.

4. The system of claim 1, wherein the spring-loaded catch comprises a locking region for receiving the heater retaining panel and the removable cover panel.

5. The system of claim 1, wherein the heater retaining panel is configured to hold the heater along two surfaces of the heater.

6. The system of claim 1, wherein the cover panel further comprises a cover retainer extending from a cover member configured to enclose two sides of the heater.

7. The system of claim 6, wherein the cover panel further comprises a cover lip extending from the cover retainer, the cover lip configured to engage the base panel.

8. The system of claim 1, wherein the heater comprises at least one of heat tape, heating tubing and heat cable.

9. The system of claim 1, wherein the heater comprises at least one heater core selected from the group comprising: channeled aluminum block, concrete-like planking material and plastic.

10. The system of claim 1, wherein the base panel, the heater retaining panel and the cover panel comprise copper.

11. The system of claim 1, without the heat retaining panel.

12. A method of installing a roof eaves ice melting system on roof eaves, comprising:
providing the roof eaves ice melting system, the system comprising:
a base panel adapted for installation on a top surface of roof eaves, the base panel further including a spring-loaded catch along an upper end and a lower end configured to wrap around a roof edge;
a heater retaining panel comprising a retainer hook configured to engage the spring-loaded catch at one edge and configured with a heater retainer member at an opposite edge;
a heater configured for resting on the heater retaining panel and adjacent to the heater retainer member, the heater further configured for selectively generating heat sufficient to melt ice or snow; and
a removable cover panel comprising a cover hook configured for engaging the spring-loaded catch and configured for enclosing the heater between the base panel and the removable cover panel; and
attaching the base panel to a roof top and roof edge;
attaching the heater retaining panel to the base panel;
placing the heater on the heater retaining panel; and
attaching the removable cover panel to the base panel and enclosing the heater.

13. The method according to claim 12, wherein attaching the base panel comprises hammering nails into the roof top and roof edge.

14. The method according to claim 12, further comprising installing heater cable in the heater and selectively providing electricity to the heater cable.

15. The method according to claim 12, wherein attaching the removable cover panel comprises inserting a cover hook into a spring-loaded catch on the base panel and wrapping a cover lip around a D-style drip edge on the base panel.

16. A roof eaves ice melting system, comprising:
a base panel for installation on a top surface of roof eaves, the base panel comprising a first hook at an upper end and a second hook at a lower end, the second hook configured to wrap around a drip edge;
a heater, the heater comprising;
a heater core; and
a heating element in thermal communication with the heater core; and
a removable cover panel having an upper hook configured for mechanical engagement with the first hook and a lower hook configured for wrapping around the first hook and the heater, the cover panel further configured for encasing the heater between the cover panel and the base panel.

17. The melting system according to claim 16, further comprising a heat core retaining panel between the base panel and the heater, the heat core retaining panel having a hook for retaining the heater.
